(19) United States
(12) Patent Application Publication
(10) Pub. No.: US 2015/0107805 A1
(43) Pub. Date: Apr. 23, 2015

(54) ELECTRIC VEHICLE THERMAL BARRIER

(71) Applicant: Ford Global Technologies, LLC, Dearborn, MI (US)

(72) Inventors: Quazi Hussain, Holland, OH (US); William Samual Schwartz, Pleasant Ridge, MI (US); Mark John Jennings, Saline, MI (US); David Richens Brigham, Ann Arbor, MI (US)

(73) Assignee: Ford Global Technologies, LLC, Dearborn, MI (US)

(21) Appl. No.: 14/058,631

(22) Filed: Oct. 21, 2013

(51) Int. Cl. B60R 13/08; B60K 11/08; B60K 11/06

(52) U.S. Cl. CPC B60R 13/0838; B60K 11/06; B60K 11/085; Y10S 903/952
USPC 165/135; 454/143; 180/65.225; 903/952

(57) ABSTRACT

An electric vehicle powertrain according to an exemplary aspect of the present disclosure includes, among other things, a thermal barrier secured relative to an engine, a transaxle, or both to retain thermal energy generated during operation of an electric vehicle.

### BACKGROUND

This disclosure relates generally to an electric vehicle and, more particularly, to a thermal barrier to retain thermal energy within portions of an electric vehicle powertrain

Generally, electric vehicles differ from conventional motor vehicles because electric vehicles are selectively driven using one or more battery-powered electric machines. Conventional motor vehicles, by contrast, rely exclusively on an internal combustion engine to drive the vehicle. Electric vehicles may use electric machines instead of, or in addition to, the internal combustion engine.

Example electric vehicles include hybrid electric vehicles (HEVs), plug-in hybrid electric vehicles (PHEVs), and battery electric vehicles (BEVs). Electric vehicles are typically equipped with a battery pack containing multiple battery cells that store electrical power for powering the electric machine. The battery cells may be charged prior to use, and recharged during a drive by a regenerative braking system or engine.

When the electric vehicle is not operating, thermal energy from a powertrain of the electric vehicle moves to the surrounding environment. This movement of thermal energy lowers the temperature of the powertrain. Key mechanical elements of the powertrain operate more efficiently when their components are relatively hot. Operating the electric vehicle generates thermal energy, which can raise and maintain the temperature of the powertrain to temperatures corresponding to efficient operation. Efficiency improvements come primarily from two sources.

The first source is the reduction of friction related losses in the engine and transaxle lubricating fluids. These fluids need less energy to airflow at higher temperatures due to reduced viscosity.

The second source, often more important, is that a hybrid electric powertrain can only operate in fully electric mode (engine off) when the powertrain temperature reaches a certain threshold value. When the powertrain is below this critical temperature, the internal combustion engine stays on regardless of the power demand. Hence, the possibility to reduce fuel consumption by operating the vehicle in electric mode is compromised.

Reaching the temperatures corresponding to efficient operation takes longer in relatively colder environments because the starting temperature of the components is lower. Further, after starting the electric vehicle in colder environments, some thermal energy is typically redirected to the cabin to comfort the driver.

### SUMMARY

An electric vehicle powertrain according to an exemplary aspect of the present disclosure includes, among other things, a thermal barrier secured relative to an engine, a transaxle, or both to retain thermal energy generated during operation of an electric vehicle.

In a further, non-limiting embodiment of the foregoing electric vehicle powertrain, the thermal barrier is secured to an exterior surface.

In a further, non-limiting embodiment of any of the foregoing electric vehicle powertrains, the thermal barrier is secured to an interior surface.

In a further, non-limiting embodiment of any of the foregoing electric vehicle powertrains, the thermal barrier comprises an insulative panel.

In a further, non-limiting embodiment of any of the foregoing electric vehicle powertrains, the thermal barrier comprises an integral portion of the engine or the transaxle.

In a further, non-limiting embodiment of any of the foregoing electric vehicle powertrains, the thermal barrier is secured directly to an engine block of the engine.

In a further, non-limiting embodiment of any of the foregoing electric vehicle powertrains, the thermal barrier is secured directly to a transaxle case of the transaxle.

In a further, non-limiting embodiment of any of the foregoing electric vehicle powertrains, the thermal barrier is separate and distinct from the engine and the transaxle.

In a further, non-limiting embodiment of any of the foregoing electric vehicle powertrains, at least one thermal barrier is secured to both the engine and the transaxle.

In a further, non-limiting embodiment of any of the foregoing electric vehicle powertrains, the thermal barrier is an expandable insulation.

In a further, non-limiting embodiment of any of the foregoing electric vehicle powertrains, the thermal barrier is a spray on insulation.

In a further, non-limiting embodiment of any of the foregoing electric vehicle powertrains, the electric vehicle is a hybrid electric vehicle.

In a further, non-limiting embodiment of any of the foregoing electric vehicle powertrains, a vehicle includes the electric vehicle powertrain, the vehicle includes a panel that is moveable between a retracted position that permits a first amount of airflow to the electric vehicle powertrain when the vehicle is operating, and an extended position that permits a second amount of airflow to the electric vehicle powertrain when the vehicle is not operating, the first amount of airflow greater than the second amount of airflow.

In a further, non-limiting embodiment of any of the foregoing electric vehicle powertrains, a vehicle includes the electric vehicle powertrain, the vehicle includes at least one grille shutter that is moveable between a first position that permits a first amount of airflow to the electric vehicle powertrain when the vehicle is operating, and an second position that permits a second amount of airflow to the electric vehicle powertrain when the vehicle is not operating, the first amount of airflow greater than the second amount of airflow.

A method of retaining thermal energy within an electric vehicle powertrain according to an exemplary aspect of the present disclosure includes, among other things, securing a thermal barrier to an engine, a transaxle, or both to retain thermal energy generated during operation of an electric vehicle.

In a further-non-limiting embodiment of the foregoing method, the method includes securing the thermal barrier directly to an engine block of the engine, the thermal barrier separate and distinct from the engine block.

In a further-non-limiting embodiment of any of the foregoing methods, the method includes securing the thermal barrier directly to transaxle case, the thermal barrier separate and distinct from the transaxle case.

In a further-non-limiting embodiment of any of the foregoing methods, the method includes operating a vehicle that is propelled using the electric vehicle powertrain, and actuating at least one grille shutter between a first position that permits a first amount of airflow to the electric vehicle powertrain when the vehicle is operating, and a second position that permits a second amount of airflow to the electric vehicle powertrain when the vehicle is not operating, the first amount of airflow greater than the second amount of airflow.

In a further-non-limiting embodiment of any of the foregoing methods, the method includes operating a vehicle that is propelled using the electric vehicle powertrain, and moving a panel between a retracted position that permits a first amount of airflow to the electric vehicle powertrain when the vehicle is operating, and an extended position that permits a second amount of airflow to the electric vehicle powertrain when the vehicle is not operating, the first amount of airflow greater than the second amount of airflow.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of an example powertrain architecture for an electric vehicle.

FIG. 2 illustrates a highly schematic view of an engine of the powertrain of FIG. 1.

FIG. 3 illustrates a perspective view of a transaxle assembly of the powertrain of FIG. 1.

FIG. 4 illustrates a section view at line 4-4 in FIG. 3.

FIG. 5 shows a highly schematic view of the engine of FIG. 2 within an engine compartment.

FIG. 6 shows a highly schematic view of the engine of FIG. 2 within the engine compartment.

### DETAILED DESCRIPTION

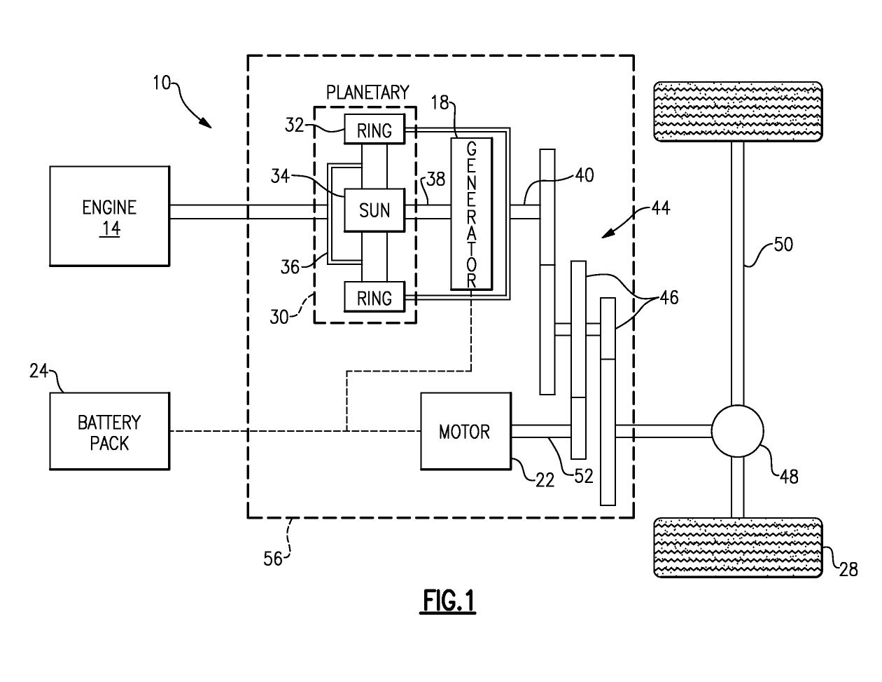

FIG. 1 schematically illustrates a powertrain 10 for an electric vehicle. Although depicted as a hybrid electric vehicle (HEV), it should be understood that the concepts described herein are not limited to HEVs and could extend to other electrified vehicles, including, but not limited to, plug-in hybrid electric vehicles (PHEVs) and battery electric vehicles (BEVs).

In one embodiment, the powertrain 10 is a powersplit hybrid electric propulsion system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electric vehicle.

The engine 14, which is an internal combustion engine in this example, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 may be driven by engine 14 through the power transfer unit 30 to convert mechanical energy to electrical energy. The generator 18 can alternatively function as a motor to convert electrical energy into mechanical energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 can be used for regenerative braking in which the motor 22 absorbs torque from the wheels 28 through gears 48 and 42 and shaft 52 and outputs electrical power to the battery pack 24.

The battery pack 24 is an example type of electric vehicle battery assembly. The battery pack 24 may be a high voltage battery that is capable of outputting electrical power to operate the motor 22 and the generator 18. Other types of energy storage devices and/or output devices can also be used with the electric vehicle.

A transaxle assembly 56 includes, in this example, at least the motor 22 and the generator 18. The power transfer unit 30 is also housed within the transaxle assembly 56.

Referring now to FIG. 2 with continuing reference to FIG. 1, one or more thermal barriers 60 are secured to external surfaces 64 of the engine 14 to retain thermal energy within the engine 14. The thermal energy may be generated by the engine 14 during operation. The thermal barrier 60 slows movement of thermal energy from the engine 14. The engine 14 thus retains thermal energy longer than another engine that does not include thermal barriers 60.

In place of, or in addition to, the thermal barriers 60, at least one internal thermal barrier 60a may be secured against an internal surface 68 of the engine 14. The internal thermal barrier 60a slows movement of thermal energy from the engine 14. The engine 14 thus retains thermal energy for a longer period than if the engine 14 lacked the internal thermal barrier 60a.

The external surfaces 64 of the engine 14 correspond generally to the outermost surfaces of the engine 14, such as the outermost surfaces of an engine block. The external surfaces 64 face outwardly away from other portions of the engine 14. The internal surfaces 68 correspond to other surfaces of the engine 14, such as the surfaces establishing cylinders or other cavities within the engine 14.

In some examples, the thermal barrier 60a is an expandable insulation blown through portions of the engine 14. During installation, the insulation expands against the internal surfaces 68 to hold the position of the insulation and provide the thermal barrier 60a.

Notably, the internal thermal barrier 60a may experience a longer life when compared to the thermal barrier 60. The longer life is due to lessened durability concerns because of its location internal to the engine 14. The internal thermal barrier 60a is internal to the engine 14 and less exposed to natural elements than the thermal barrier 60 secured to the external surfaces 64 of the engine 14.

In some examples, the engine 14 is designed to include one or more cavities or channels 76. A thermal barrier 60′ is sized to be received within the channel 76. The thermal barrier 60′ may be an expandable insulation blown into the channel 76 and expands against the walls of the channels 76 to hold the expandable insulation and provide the thermal barrier.

The thermal barriers 60, 60′ and 60a could also comprise spray on insulation in some examples.

The thermal barriers 60, 60′ and 60a cause the engine 14 to retain heat more effectively than an engine lacking thermal barriers. The retained heat allows the engine 14 to start from a higher temperature relative to an engine lacking thermal barriers. Thermal energy convects away from the engine 14 more slowly than in another engine lacking the thermal barriers.

In this example, the barriers 60, 60′, and 60a can be insulative panels that are directly secured to the engine 14. The barriers 60, 60′ and 60a can also be separate and distinct from the engine 14. The barriers 60, 60′ and 60a can be flame retardant, non-toxic, and relatively lightweight.

The engine 14, including the cylinder head, engine block, and the oil pan area, can have thermal barriers 60, 60′, and 60a to slow down the rate of heat loss. If the thermal barriers 60, 60′, and 60a are insulation panels, they can be secured by screws or other mechanical fastening devices to the external or internal surfaces of the engine 14. Alternatively, the thermal barriers 60, 60′, and 60a can be secured in place by adhesives or deposited on the surface by some suitable industrial process.

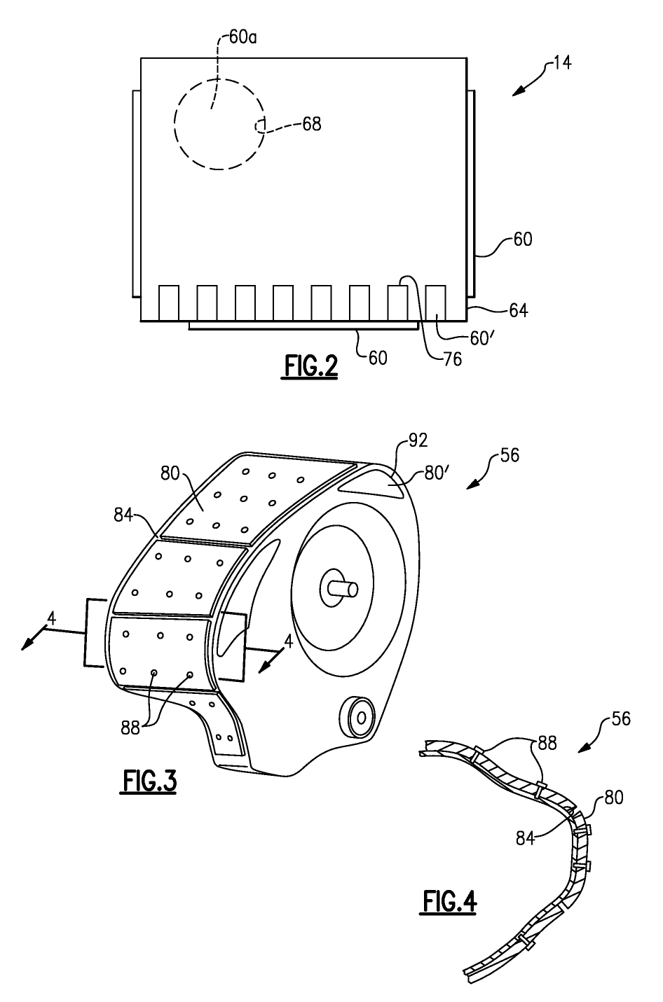

Referring now to FIGS. 3 and 4, the transaxle 56 may include thermal barriers 80 that are secured to exterior surfaces 84 of the transaxle 56. Other thermal barriers (not shown) may be secured to internal surfaces of the transaxle 56 instead of, or in addition to, the thermal barrier 80 secured to the external surface 84.

The thermal barrier 80 can be secured to the external surface 84 with a screw 88, or another type of mechanical fastener, adhesive, etc. In this example, the screws 88 are threaded into the transaxle 56.

One or more channels 92 or pockets can be provided in the transaxle 56 to receive a blown expandable insulation that provides another thermal barrier 80′.

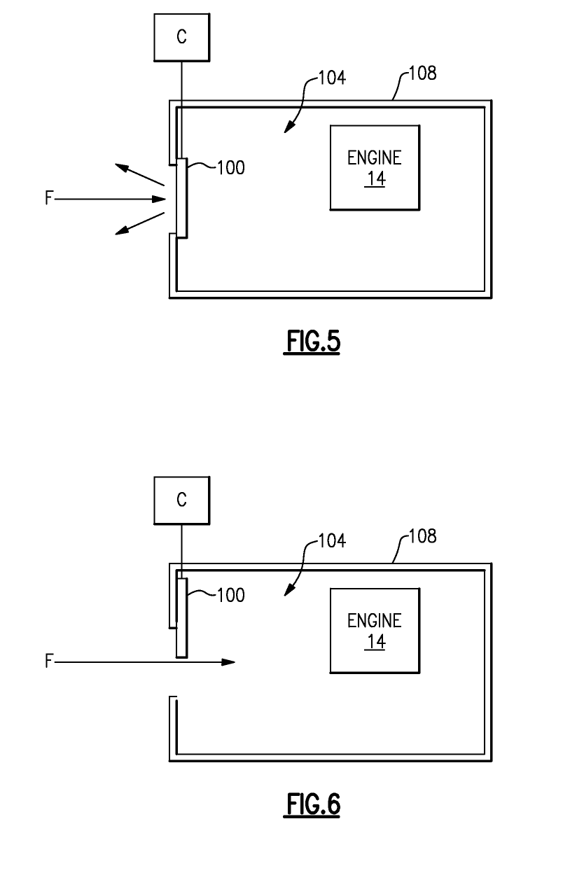

Referring now to FIGS. 5 and 6, a contributing factor to thermal energy moving from the engine 14 and the transaxle 56 (not shown) is a flow F of air, for example, around the engine 14 and the transaxle 56, even when the vehicle associated with the engine 14 and the transaxle 56 is not running. The airflow F moves from the area surrounding an engine compartment 108 across the engine 14.

In this example, a movable device 100 is moved to a first position (FIG. 5) to limit cold air from an exterior of the vehicle from entering an interior 104 of the engine compartment 108. A controller C is configured to actuate the movable device 100 between the position shown in FIG. 5 that prevents less airflow into the interior 104, and the position shown in FIG. 6 that permits more airflow into the interior 104. The controller C may actuate the moveable device 100 in response to temperature. For example, the controller C may cause the moveable device 100 to move to the position of FIG. 5 when an air temperature outside the interior 104 is less than the temperature inside 104 by a pre-determined amount, such as 10 degrees F., for example.

Typically, the moveable device 100 is not utilized as described above if there is only a relatively small difference between the temperature of the interior 104 and the temperature outside the engine compartment 108. Preventing a small amount of heat loss would not justify the energy, such as electricity, used to actuate the movable device 100, for example.

The position of the moveable device 100 shown in FIG. 6 corresponds to the desired position for the moveable device 100 when the vehicle is operating and the engine 14 is generating thermal energy. The position of the moveable device 100 can be selectively varied to permit more or less airflow into the interior 104.

In this example, the movable device 100 is a panel that is selectively extended to block airflow into the interior 104 for when the vehicle is not operating, and retracted to permit airflow into the interior 104 when the vehicle is operating.

In another example, the movable device 100 comprises one or more grille shutters that are actively moved and rotated by the controller 112 between positions that permit more airflow and positions that permit less airflow.

Features of the disclosed examples include improved fuel economy gains due to thermal energy retained within an engine of an electric vehicle, a transaxle, or both. The thermal barriers facilitate starting the electric vehicle powertrain with components having a higher internal temperature than if components did not include thermal barriers. The thermal barriers cause the components to heat at a faster rate than if the components did not include thermal barriers. The thermal barriers also may reduce noise emission from the engine, the transaxle, and other areas of the electric vehicle powertrain.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. An electric vehicle powertrain, comprising:
a thermal barrier secured relative to an engine, a transaxle, or both to retain thermal energy generated during operation of an electric vehicle.

2. The electric vehicle powertrain of claim 1, wherein the thermal barrier is secured to an exterior surface.

3. The electric vehicle powertrain of claim 1, wherein the thermal barrier is secured to an interior surface.

4. The electric vehicle powertrain of claim 1, wherein the thermal barrier comprises an insulative panel.

5. The electric vehicle powertrain of claim 1, wherein the thermal barrier comprises an integral portion of the engine or the transaxle.

6. The electric vehicle powertrain of claim 1, wherein the thermal barrier is secured directly to an engine block of the engine.

7. The electric vehicle powertrain of claim 1, wherein the thermal barrier is secured directly to a transaxle case of the transaxle.

8. The electric vehicle powertrain of claim 1, wherein the thermal barrier is separate and distinct from the engine and the transaxle.

9. The electric vehicle powertrain of claim 1, wherein at least one thermal barrier is secured to both the engine and the transaxle.

10. The electric vehicle powertrain of claim 1, wherein the thermal barrier is an expandable insulation.

11. The electric vehicle powertrain of claim 1, wherein the thermal barrier is a spray on insulation.

12. The electric vehicle powertrain of claim 1, wherein the electric vehicle is a hybrid electric vehicle.

13. A vehicle including the electric vehicle powertrain of claim 1, including at least one grille shutter moveable between a first position that permits a first amount of airflow to the electric vehicle powertrain when the vehicle is operating, and a second position that permits a second amount of airflow to the electric vehicle powertrain when the vehicle is not operating, the first amount of airflow greater than the second amount of airflow.

14. A vehicle including the electric vehicle powertrain of claim 1, including a panel that is moveable between a retracted position that permits a first amount of airflow to the electric vehicle powertrain when the vehicle is operating, and an extended position that permits a second amount of airflow to the electric vehicle powertrain when the vehicle is not operating, the first amount of airflow greater than the second amount of airflow.

15. A method of retaining thermal energy within an electric vehicle powertrain, comprising:
securing a thermal barrier to an engine, a transaxle, or both to retain thermal energy generated during operation of an electric vehicle.

16. The method of claim 15, including securing the thermal barrier directly to an engine block of the engine, the thermal barrier separate and distinct from the engine block.

17. The method of claim 15, including securing the thermal barrier directly to transaxle, the thermal barrier separate and distinct from the transaxle case.

18. The method of claim 15, including operating a vehicle that is propelled using the electric vehicle powertrain, and
actuating at least one grille shutter between a first position that permits a first amount of airflow to the electric vehicle powertrain when the vehicle is operating, and a second position that permits a second amount of airflow to the electric vehicle powertrain when the vehicle is not operating, the first amount of airflow greater than the second amount of airflow.

19. The method of claim 18, including operating a vehicle that is propelled using the electric vehicle powertrain, and
moving a panel between a retracted position that permits a first amount of airflow to the electric vehicle powertrain when the vehicle is operating, and an extended position that permits a second amount of airflow to the electric vehicle powertrain when the vehicle is not operating, the first amount of airflow greater than the second amount of airflow.
